(19) United States
(12) Patent Application Publication
(10) Pub. No.: US 2022/0070086 A1
(43) Pub. Date: Mar. 3, 2022

(54) OPTIMAL PROACTIVE ROUTING WITH GLOBAL AND REGIONAL CONSTRAINTS

(71) Applicant: Cisco Technology, Inc., San Jose, CA (US)

(72) Inventors: Grégory Mermoud, Venthône (CH); Jean-Philippe Vasseur, Saint Martin D'uriage (FR); Vinay Kumar Kolar, San Jose, CA (US)

(21) Appl. No.: 17/007,362

(22) Filed: Aug. 31, 2020

(51) Int. Cl. H04L 12/707; H04L 12/24; H04L 12/721; G06N 20/00; G06N 7/00

(52) U.S. Cl. CPC H04L 45/22; H04L 41/5025; G06N 7/005; G06N 20/00; H04L 45/14

(57) ABSTRACT

In one embodiment, a device in a network obtains probabilities of service level agreement violations predicted to occur in the network. The device generates, based in part on the probabilities, a plurality of rerouting patches for the network that reroute traffic in the network to avoid the service level agreement violations predicted to occur in the network. The device forms, based on the plurality, a set of rerouting patches that comprises at least a portion of the plurality, by applying an objective function to the plurality of rerouting patches and using one or more size constraints. The device applies the set of rerouting patches to the network, prior to when the service level agreement violations are predicted to occur in the network.

### TECHNICAL FIELD

The present disclosure relates generally to computer networks, and, more particularly, to anomaly detection triggered proactive routing for software as a service (SaaS) application traffic.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs.

Failure detection in a network has traditionally been reactive, meaning that the failure must first be detected before rerouting the traffic along a secondary (backup) path. In general, failure detection leverages either explicit signaling from the lower network layers or using a keep-alive mechanism that sends probes at some interval T that must be acknowledged by a receiver (e.g., a tunnel tail-end router). Typically, SD-WAN implementations leverage the keep-alive mechanisms of Bidirectional Forwarding Detection (BFD), to detect tunnel failures and to initiate rerouting the traffic onto a backup (secondary) tunnel, if such a tunnel exits. While this approach is somewhat effective at mitigating tunnel failures in an SD-WAN, reactive failure detection is also predicated on a failure first occurring. This means that traffic will be affected by the failure, until the traffic is moved to another tunnel.

With the recent evolution of machine learning, predictive failure detection in an SD-WAN now becomes possible through the use of machine learning techniques. This provides for the opportunity to implement proactive routing whereby traffic in the network is rerouted before an SLA violation occurs. However, in practice, there may be a limit to the number of rerouting patches that can be applied in the network at any given time, which can lead to suboptimal results.

### BRIEF DESCRIPTION OF THE DRAWINGS

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for optimizing proactive routing in a network using constraints; and

FIG. 6 illustrates an example simplified procedure to apply rerouting patches to a network.

### DESCRIPTION OF EXAMPLE EMBODIMENTS

### Overview

According to one or more embodiments of the disclosure, a device in a network obtains probabilities of service level agreement violations predicted to occur in the network. The device generates, based in part on the probabilities, a plurality of rerouting patches for the network that reroute traffic in the network to avoid the service level agreement violations predicted to occur in the network. The device forms, based on the plurality, a set of rerouting patches that comprises at least a portion of the plurality, by applying an objective function to the plurality of rerouting patches and using one or more size constraints. The device applies the set of rerouting patches to the network, prior to when the service level agreement violations are predicted to occur in the network.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

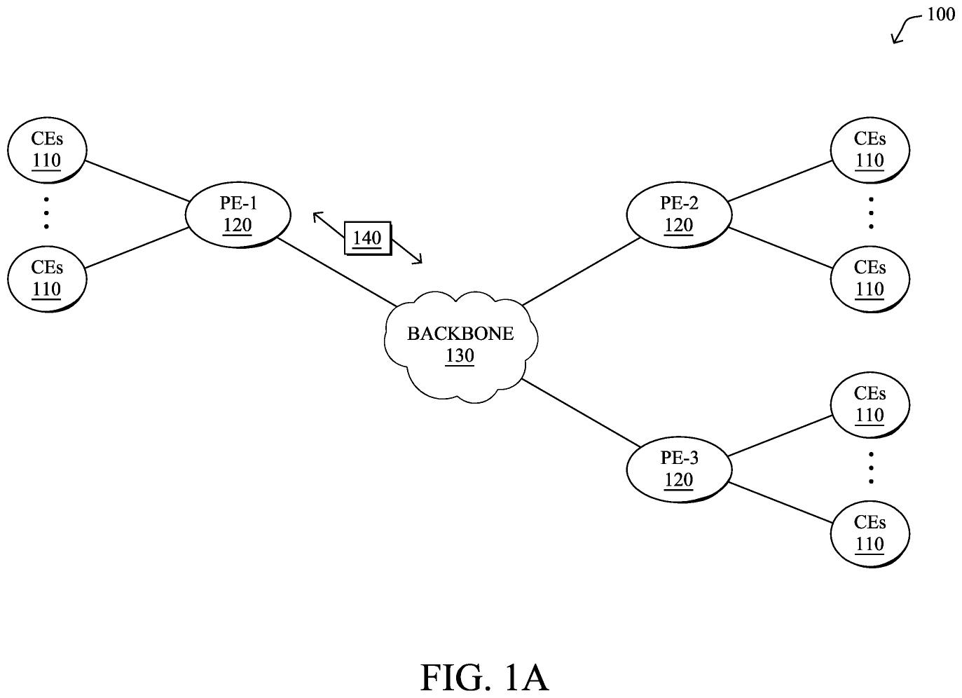

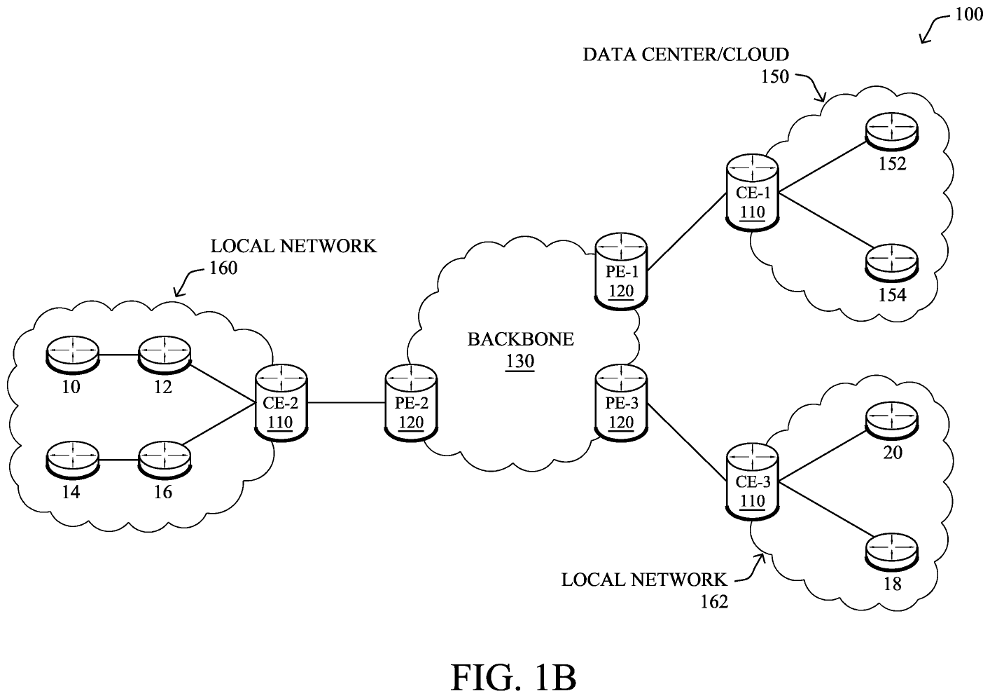

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud 150 on top of the various underlying connections. Another feature of SD-WAN is centralized management by a supervisory service that can monitor and adjust the various connections, as needed.

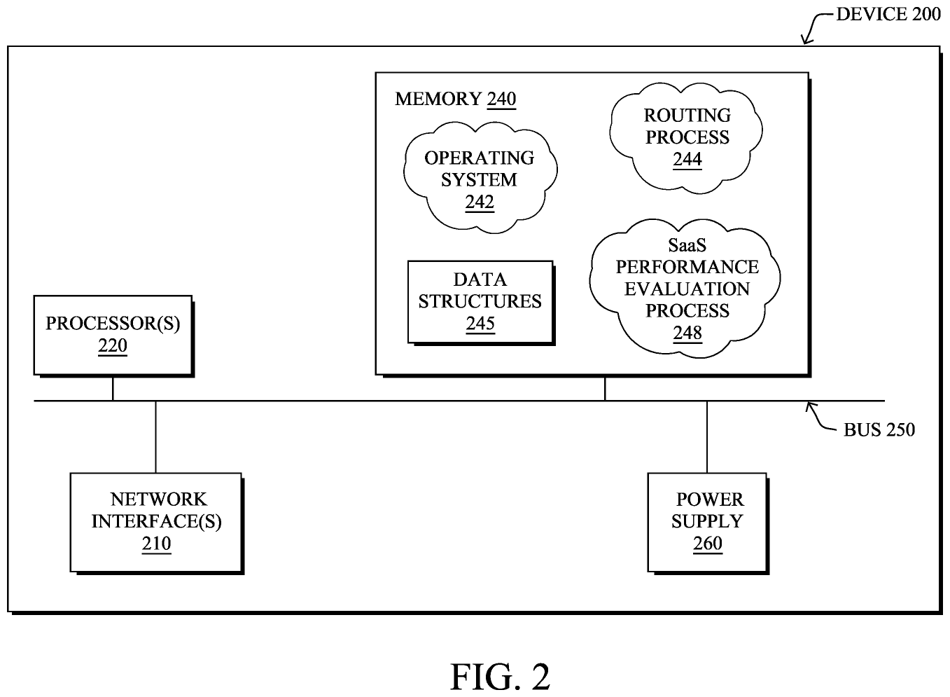

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a routing process 244 and/or a software as a service (SaaS) performance evaluation process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing process (services) 244 contains computer executable instructions executed by the processor 220 to perform functions provided by one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, SaaS performance evaluation process 248 may also include computer executable instructions that, when executed by processor(s) 220, cause device 200 to perform the techniques described herein. To do so, in some embodiments, SaaS performance evaluation process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, SaaS performance evaluation process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that SaaS performance evaluation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted that conditions in the network will result in an unacceptable quality of experience (QoE) associated with an application. Conversely, the false negatives of the model may refer to the number of times the model incorrectly predicted an acceptable QoE. True negatives and positives may refer to the number of times the model correctly predicted whether the QoE will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different quality of service (QoS) at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

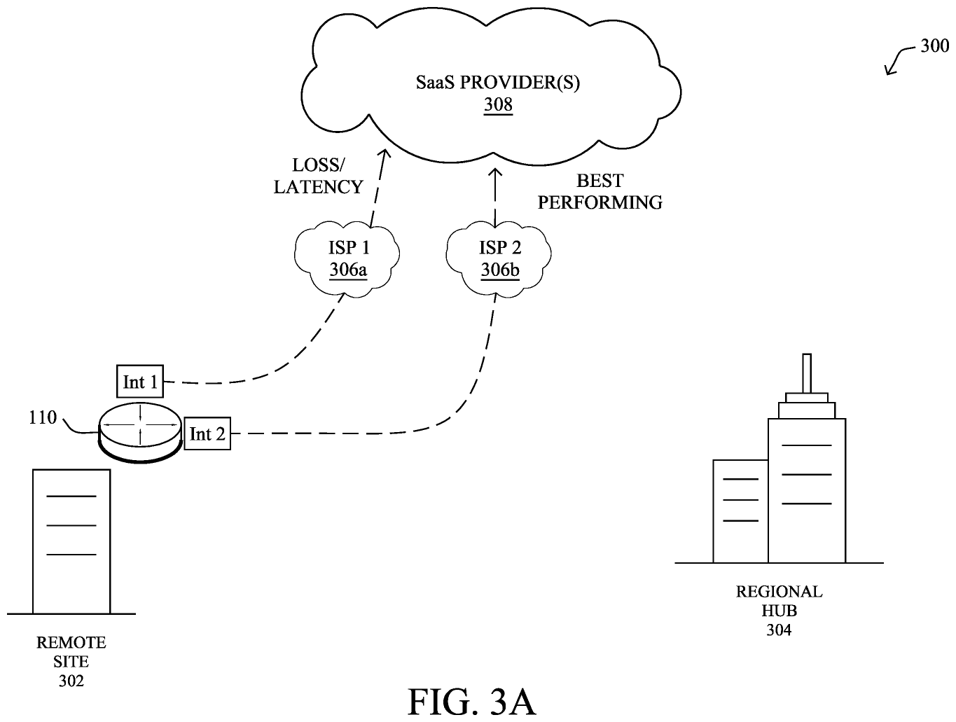

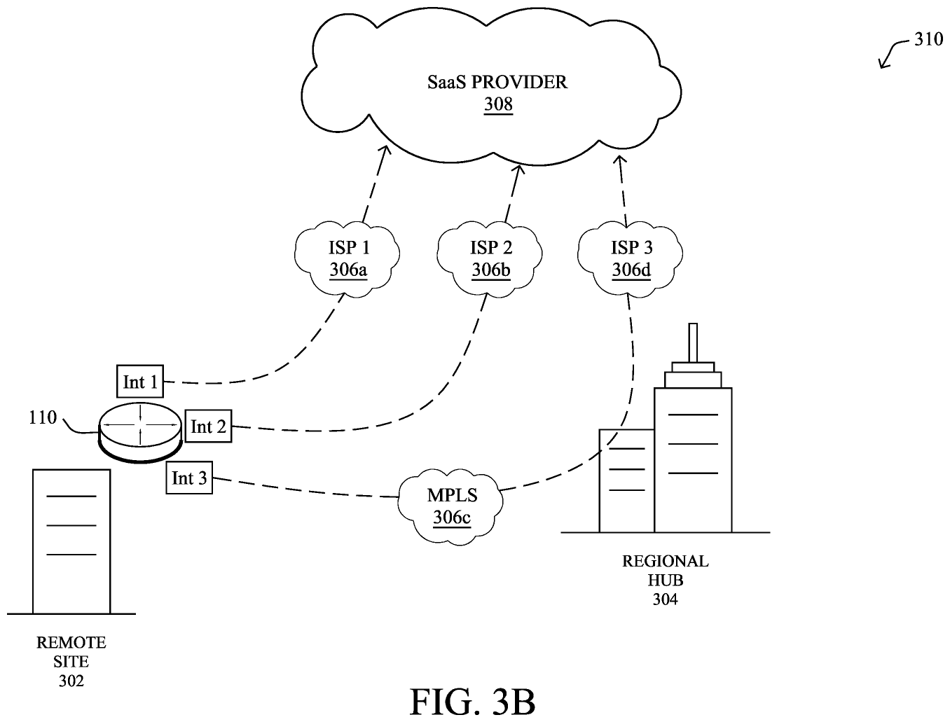

FIGS. 3A-3B illustrate example network deployments 300, 310, respectively. As shown, a router 110 (e.g., a device 200) located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

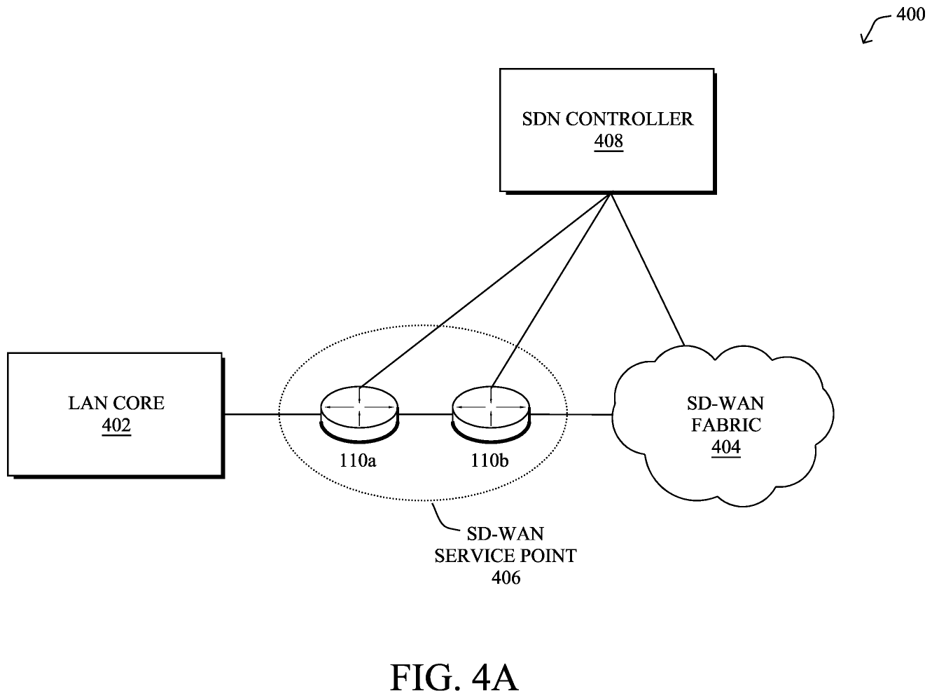

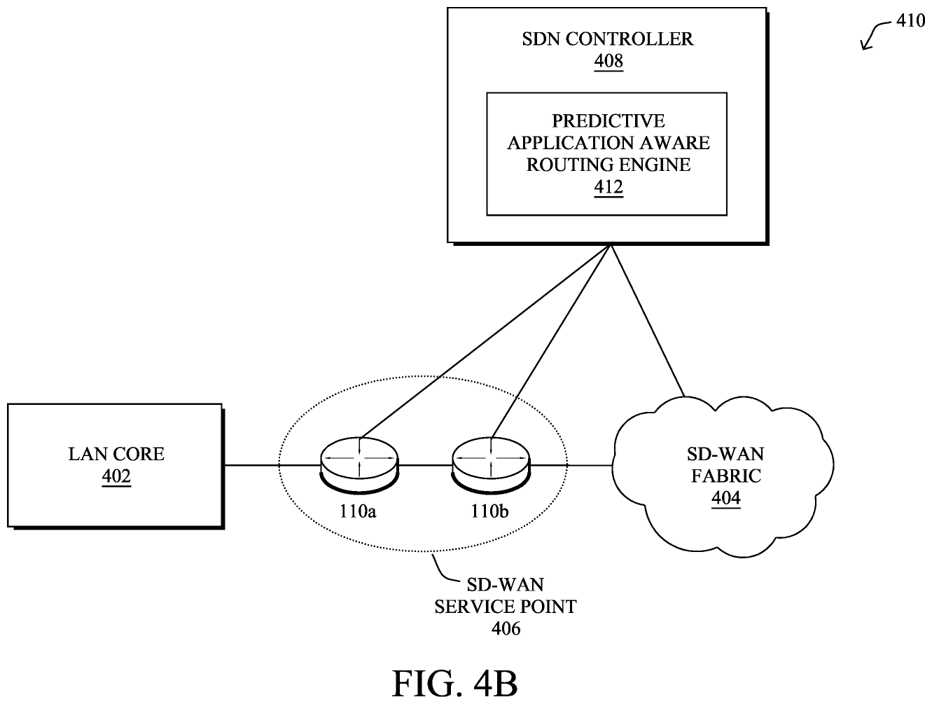

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., devices 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the QoE from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing s still entirely reactive: decisions are made using probes that reflect the status of a path at a given time, in contrast with the notion of an informed decision.
SLA failures are very common in the Internet and a good proportion of them could be avoided (using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes. In other words, predictive application aware routing engine 412 may first predict SLA violations in the network that could affect the QoE of an application and then implement a corrective measure, such as rerouting the traffic of the application, prior to the predictive SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment.

As noted above, predictive application aware routing prevents application disruptions by forecasting SLA violations and applying a new routing decision, referred to herein as a ‘patch,’ on the fly. This allows the configuration of the edge router to continually update the preferred path (e.g., tunnel) for the application traffic. However, the number of patches that is supported by a given router or acceptable to an administrator may be limited. Indeed, such operations are costly from a backend perspective and rerouting may also have an impact on the traffic, itself, such as by incurring packet re-orderings, packet loss, and the like.

——Optimal Proactive Routing with Global and Regional Constraints——

The techniques introduced herein introduce a series of mechanisms able to limit the number of rerouting patches applied by a proactive routing engine, given one or more global or regional constraints. In some aspects, the techniques herein may be used to generate rerouting patches to avoid predicted SLA violations and, in turn, select an optimal set of rerouting patches for the network that maximize an objective metric, such as an amount of time that a particular patch would avoid a predicted SLA violation or a number of sessions in the network that the particular patch would save.

Illustratively, the techniques described herein may be performed by hardware, software, and/or firmware, such as in accordance with the SaaS performance evaluation process 248, which may include computer executable instructions executed by the processor 220 (or independent processor of interfaces 210) to perform functions relating to the techniques described herein (e.g., in conjunction with routing process 244).

Specifically, according to various embodiments, a device in a network obtains probabilities of service level agreement violations predicted to occur in the network. The device generates, based in part on the probabilities, a plurality of rerouting patches for the network that reroute traffic in the network to avoid the service level agreement violations predicted to occur in the network. The device forms, based on the plurality, a set of rerouting patches that comprises at least a portion of the plurality, by applying an objective function to the plurality of rerouting patches and using one or more size constraints. The device applies the set of rerouting patches to the network, prior to when the service level agreement violations are predicted to occur in the network.

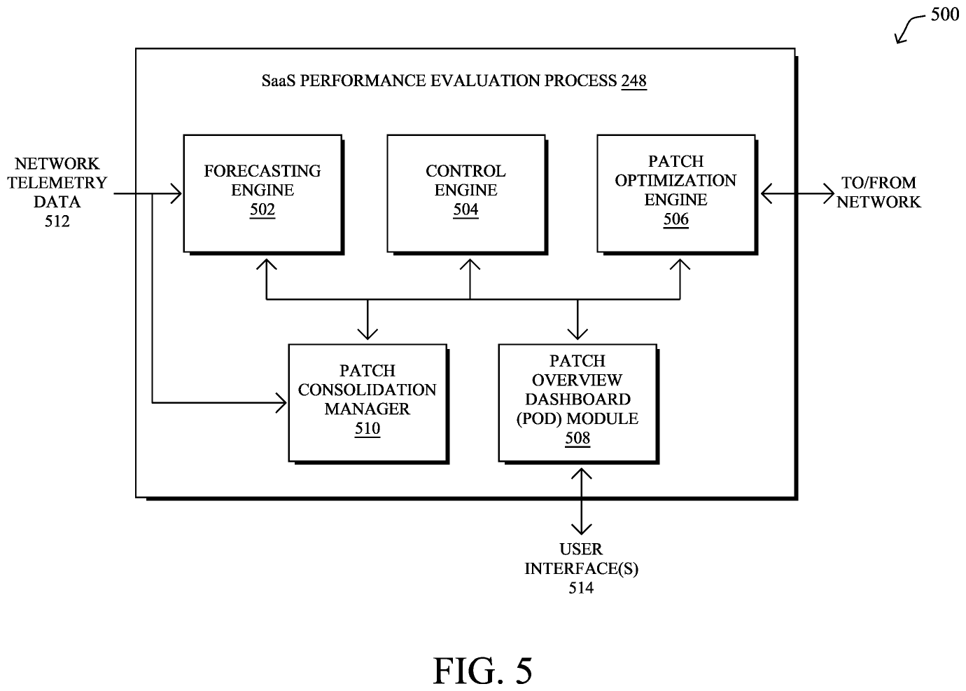

Operationally, FIG. 5 illustrates an example architecture 500 optimizing proactive routing in a network using constraints. As shown, SaaS performance evaluation process 248 may include any or all of the following components: a forecasting engine 502, a control engine 504, a patch optimization engine 506, a patch overview dashboard (POD) module 508, and/or a patch consolidation manager 510. As would be appreciated, the functionalities of these components may be combined or omitted, as desired. In addition, these components may be implemented on a singular device or in a distributed manner, in which case the combination of executing devices can be viewed as their own singular device for purposes of executing SaaS performance evaluation process 248.

In various embodiments, SaaS performance evaluation process 248 may include forecasting engine 502 that is configured to take as input network telemetry data 512 (e.g., measured loss, jitter, delays, etc. along the network paths/tunnels) and generate a probabilistic forecast Pr_{p,i} that a path p will exhibit an SLA violation during a time interval i. For instance, forecasting engine 502 may include one or more time-series models, such as an AutoRegressive Integrated Moving Average (ARIMA)-based model, a Long Short-Terni Memory (LSTM)-based model, or the like, and may, in some embodiments, also generate an uncertainty estimate σ_{p,i} for its forecast.

In further embodiments, SaaS performance evaluation process 248 may also include control engine 504, which consumes the probabilities generated by forecasting engine 502 and produces a set of what are referred to herein as ‘rerouting patches.’ For instance, control engine 504 may search for alternate paths between a source and destination of a path predicted to experience an SLA violation onto which the traffic may be rerouted. In general, a rerouting patch may be characterized by any or all of the following attributes:
A list of one or more relevant applications whose traffic is to be rerouted. For instance, this listing may use the same set of application identifiers as an application recognition engine in the network configured to identify the application associated with a particular traffic flow, such as a Network-Based Application Recognition (NBAR) engine by Cisco Systems or the like.
A source path p on which an SLA violation was predicted to occur with respect to the traffic for the relevant application(s).
A target path p′ onto which the traffic for the relevant application(s) may be rerouted that is not expected to exhibit an SLA violation.
A time interval [t₁,t₂] during which the rerouting shall be active.

Based on the probabilities produced by the forecasting engine 502, control engine 504 may generate a plurality of rerouting patches to avoid the predicted SLA violations from occurring, based on the probabilities determined by forecasting engine 502. At a high level, control engine 504 may identify situations where the probability Pr_{p,i} for a path p is significantly larger than Pr_{p,i} for an alternate path p′, where an alternate path refers to a different path than that of path p that shares the same source and destination as that of path p. In such cases, control engine 504 may generate a rerouting patch to reroute any relevant traffic from source path p to target path p′ during time interval i, in advance of the predicted SLA violation(s) occurring on path p.

As shown, SaaS performance evaluation process 248 may also include patch optimization engine 506, which functions to limit the number of rerouting patches to be applied to the network, while maximizing an objective function. In one embodiment, the objective function may be an (expected) cumulative amount of time (e.g., number of minutes, hours, etc.) of SLA violations that would be averted by applying the set of rerouting patches. For instance, patch optimization engine 506 may determine that a particular set of rerouting patches will result in a savings of twenty-five minutes less of SLA violations, if applied to the network. In another embodiment, the objective function may seek to maximize the number of sessions saved from SLA violations by the patches. In another embodiment, the objective function may seek to maximize the number of users saved from being affected by the SLA violation(s). As would be appreciated, patch optimization engine 506 may use other objective functions in further implementations, such as combinations of the above and/or other criteria, as desired.

According to various embodiments, patch optimization engine 506 may select rerouting patches for inclusion in the set to be applied to the network that maximize its objective function (or minimize it, depending on its criteria), given one or more size constraints. More specifically, the one or more constraints may limit the number of rerouting patches to be applied at a given point in time across the whole network or to a subpart of it (e.g., a single router, etc.). For instance, one size constraint may limit the total number of concurrent patches that can be applied to two hundred and fifty, globally, and to five per edge router. These size limits are denoted N_{global} and Nᵣₒᵤₜₑᵣ. In further embodiments, other constraints could also be used, such as by limiting the set of rerouting patches to a total number of rerouting patches per model of router in the network, potentially on a differentiated basis (e.g., different models may have different limits), geographic region in which the network is located, or an area of the network. Note that the constraints can also be applied cumulatively, in some instances (e.g., a global constraint and a router constraint, etc.).

In a simple embodiment, patch optimization engine 506 may take as input the plurality of rerouting patches generated by control engine 504 and compute, for each of them, their expected reward. Such a reward may, for instance, represent the expected improvement to the score of the objective function, were that rerouting patch applied to the network. For instance, if the objective function related to the number of minutes of SLA failures saved, patch optimization engine 506 may determine that applying a particular patch to the network will increase the number of minutes by ten. In turn, in various embodiments, patch optimization engine 506 may then rank the rerouting patches by their expected rewards and generate the final set of rerouting patches by taking the top N-number of patches according to their rankings and allocate them greedily to the routers in the network until reaching the imposed size constraint(s) (e.g., until reaching N_{global}, Nᵣₒᵤₜₑᵣ, and/or any other constraints).

In cases in which the objective is to optimize the amount of time that SLA violations are avoided, the above ranking and selection can be achieved, easily. However, when the objective function represents the number of sessions that would be saved, patch optimization engine 506 may need to forecast the activity on the network at the time of the projected failure(s). This may be done by training another timeseries model whose target is the number of sessions S_{p,i} on path p during time interval i. Using this forecast, patch optimization engine 506 can then rank the rerouting patches by a score proportional to S_{p,i}.

In a further embodiment, patch optimization engine 506 may be allowed to modify rerouting patches from control engine 504, to make them more efficient. For instance, assume that a given path p is expected to violate two distinct SLA templates A and B at the same time interval i, thus resulting in control engine 504 generating two distinct rerouting patches. In this case, patch optimization engine 506 may consolidate the two patches by merging them into a single patch whose application list is the union of the lists of each original patch.

Patch optimization engine 506 may also perform more complex patch consolidations. For instance, if successive, yet non-contiguous, time intervals are identified as violating a given SLA template, patch optimization engine 506 may decide to create a single rerouting patch that starts at the first and ends at the last interval, even if the primary path would be available at some point, in-between. More specifically, assume that two rerouting patches would reroute traffic from path p to p′, but that the first patch would apply during time interval [t₀, t₁] and the second patch would apply during time interval [t₂, t₃]. Rather than applying both patches and reverting the traffic back onto path p between times t₁ and t₂, only to reroute the traffic back onto path p′, patch optimization engine 506 may opt to generate a new rerouting patch that is to be applied during time interval [t₀, t₃], by exploring the effects of such a merger on the objective function. This type of consolidation represents a tradeoff between efficiency (e.g., number of hours or sessions saved per individual patch, other constraints, etc.) and raw efficacy and/or compliance with existing configurations (e.g., the use of the preferred path, whenever possible). The patch consolidations by patch optimization engine 506 may also be configurable, such as based on the router models, geographical regions, or network areas. In another embodiment, patch optimization engine 506 may evaluate Prₚ, for the period of non-overlapping times for both patches and, if the probability is low (e.g., below a defined threshold), patch optimization engine 506 may opt to consolidate the patches.

When the underlying platform supports it, patch optimization engine 506 may also simplify a complex ensemble of rerouting patches into a much simpler configuration change. For instance, assuming that several SLA violations are predicted on different paths p₁, p₂, and p₃ in the next twelve hours, all targeted to an alternate p₄. In such a case, patch optimization engine 506 may decide to simply set this alternate path as the default route for these twelve hours for all applications, instead of applying a dozen individual patches or not being able to avoid some of the violations at all due to a hard limit.

In another embodiment, patch optimization engine 506 may consolidate rerouting patches for different edge routers by a single path by examining the IP address and subnet masks associated with the routers. For example, if all of the edge routers with IP address a.b.c.d and subnet mask 255.255.255.192 have individual patches for rerouting via an alternative MPLS tunnel during a particular time interval, patch optimization engine 506 may consolidate these rerouting patches into a single rerouting patch to be applied.

To evaluate when to merge rerouting patches for inclusion in the set of patches for application to the network, patch optimization engine 506 may leverage metaheuristics, such as by applying a Genetic Algorithm (GA), Particle Swarm Optimization (PSO), or the like to the rerouting patches. Such algorithms belong to the class of evolutionary algorithms, which mimic biological processes such as natural selection to solve broad classes of combinatorial search and optimization problems, including NP-hard problems such as the Traveling Salesperson Problem.

SaaS performance evaluation process 248 may also include patch overview dashboard module 508, which communicates with any number of user interface(s) 514, to allow a network operator to visualize all rerouting patches currently deployed in the network. For instance, POD module 518 may provide information regarding the set of rerouting patches formed by patch optimization engine 506 to be applied to the network, as well as information regarding the rerouting patches that are already applied. In one embodiment, this allows the user(s) of user interface(s) 514 to override the decisions of patch optimization engine 506 and/or revert any deployment of patches. In a further embodiment, POD module 508 may also allow the user(s) to adjust how patch optimization engine 506 forms future sets of rerouting patches, such as by adjusting the size constraint(s) applied by patch optimization engine 506, the objective function used by patch optimization engine 506, introducing exceptions for paths, routers, or network regions that are particularly constrained, or the like. To aid in this, POD module 508 may also compute and provide estimates to user interface(s) 514 regarding any potential savings that could be achieved by relaxing some of the constraints.

Thus, patch optimization engine 506 may apply the finalized set of rerouting patches to the network, in advance of the predicted SLA violations occurring and, potentially, after seeking administrator review of the set via POD module 508. In do so, the affected traffic will be rerouted onto different paths in the network, thereby avoiding the predicted SLA violations.

In some instances, SaaS performance evaluation process 248 may also include patch consolidation manager 510 that keeps track of the individual rerouting patches generated by control engine 504 and/or the consolidated patches generated by patch optimization engine 506. In some embodiments, patch consolidation manager 510 may also monitor the actual saving achieved by these patches when applied to the network. In turn, patch consolidation manager 510 may quantify whether a particular consolidated patch is effective or performance-degrading over time when compared to individual patches.

In one embodiment, patch consolidation manager 510 may track all individual and consolidated routing suggestions of routing from path p to p′. Patch consolidation manager 510 may continually monitors the path performance metrics such as loss, latency and jitter from all paths. This can be done by patch consolidation manager 510 querying a datalake where network telemetry data 512 is stored. Patch consolidation manager 510 then may use an explicit application QoE measurement or an SLA template (e latency <150 ms, loss <3%, and jitter <50 ms for voice applications) to measures the actual savings if a particular patch were to be applied. Patch consolidation manager 510 may then compute the actual savings from the individual patches and also from their consolidated patch that was applied to the network. If the savings from using the consolidated rerouting patch is significantly less than that of its constituent patches, patch consolidation manager 510 may instruct patch optimization engine 506 to break up the consolidation and not use it in the future.

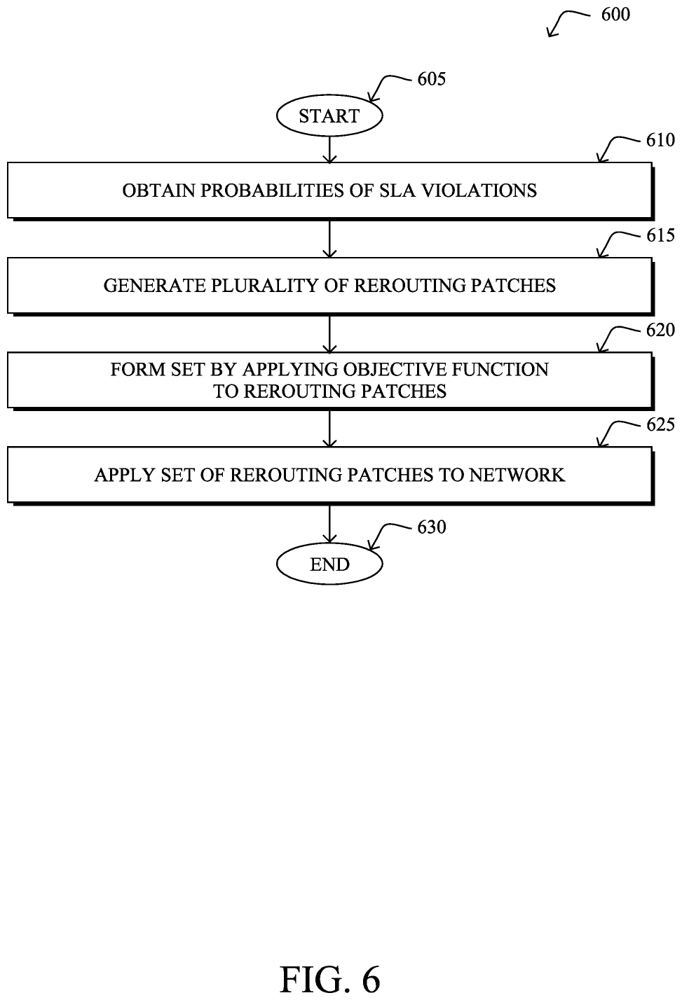

FIG. 6 illustrates an example simplified procedure to apply rerouting patches to a network, in accordance with one or more embodiments described herein. For example, a non-generic, specifically configured device (e.g., device 200), such as an SDN controller, a router, or the like, may perform procedure 600 by executing stored instructions (e.g., process 248). The procedure 600 may start at step 605, and continues to step 610, where, as described in greater detail above, the device may obtain probabilities of SLA violations predicted to occur in a network. In various embodiments, the probabilities may be generated by a machine learning model configured to predict SLA violations (and/or path failures) based on performance telemetry collected from the network. For instance, such a prediction may specify that a particular tunnel is likely to violate the SLA of voice traffic carried by that tunnel during 2:00 PM and 2:10 PM.

At step 615, as detailed above, the device may generate, based in part on the probabilities, a plurality of rerouting patches for the network that reroute traffic in the network to avoid the SLA violations predicted to occur in the network. In general, each rerouting patch may indicate that traffic currently routed on one path should be rerouted onto another path during a certain time interval and potentially on an application-by-application basis. For instance, if path A is predicted to violate the SLA of its voice traffic with a probability of 0.8 or higher, one rerouting patch may specify that that traffic should be rerouted onto path B to the same destination during the corresponding interval.

At step 620, the device may form a set of rerouting patches that comprises at least a portion of the plurality, as described in greater detail above. In various embodiments, the device may form the set of rerouting patches by applying an objective function to the plurality of rerouting patches and using one or more size constraints. For instance, the device may do so by computing an expected reward (e.g., an improvement to the objective function, such as an amount of time that the particular patch would avoid a service level agreement violation, a number of sessions in the network that the particular patch would save, etc.) and then ranking the patches by their expected rewards.

In various embodiments, the device may also form the set of rerouting patches by taking into account the one or more size constraints, such as a global constraint that limits the set of rerouting patches to a total number of rerouting patches globally across the network, a router constraint that limits the set of rerouting patches to a maximum number of rerouting patches to be applied to a particular router in the network, a constraint that limits the set of rerouting patches to a total number of rerouting patches per model of router in the network, geographic region in which the network is located, or an area of the network, combinations thereof, or the like. In a further embodiment, the device may opt to consolidate two or more patches in the plurality to generate a new rerouting patch for inclusion in the set, taking into account the size constraint(s) on the set. In another embodiment, the device may provide information regarding the set of rerouting patches to a user interface and receive an instruction via the user interface to adjust the set of rerouting patches or the one or more size constraints.

At step 625, as detailed above, the device may apply the set of rerouting patches to the network, prior to when the service level agreement violations are predicted to occur in the network. In doing so, may or all of the predicted SLA violations can be avoided. In one embodiment, the device may further obtain telemetry data indicative of network performance, after applying the set of rerouting patches to the network, and adjusting, based on the telemetry data, how the device forms future sets of rerouting patches. For instance, if a particular consolidated rerouting patch did not perform as well as its constituent patches would have, the device may block that consolidation from being performed again in the future. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow a proactive outing engine to apply a set of rerouting patches to a network in an optimal way, given one or more size constraints on the set. In some aspects, the optimization may seek to maximize the amount of time during which SLA violations are avoid, the number of sessions saved by proactively rerouting the traffic, and/or the number of users saved from being affected by SLA violations. In further aspects, the constraints on the set of rerouting patches may limit the global number of rerouting patches that can be applied at a certain time and/or the number of patches that can be applied during that time to a particular router, routers of a certain type, a geographic location, an area of the network, combinations thereof, or the like.

While there have been shown and described illustrative embodiments that provide for optimal proactive routing with global and regional constraints, it is to be understood that various other adaptations and modifications may be made within the spirit and scope of the embodiments herein. For example, while certain embodiments are described herein with respect to using certain models for purposes of predicting tunnel failures, SLA violations, or the like, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device in a network, probabilities of service level agreement violations predicted to occur in the network;
generating, by the device and based in part on the probabilities, a plurality of rerouting patches for the network that reroute traffic in the network to avoid the service level agreement violations predicted to occur in the network;
forming, by the device and based on the plurality, a set of rerouting patches that comprises at least a portion of the plurality, wherein the device forms the set of rerouting patches by applying an objective function to the plurality of rerouting patches and using one or more size constraints; and
applying, by the device, the set of rerouting patches to the network, prior to when the service level agreement violations are predicted to occur in the network.

2. The method as in claim 1, wherein the network comprises a software-defined wide area network (SD-WAN).

3. The method as in claim 1, wherein the one or more size constraints comprise a global constraint that limits the set of rerouting patches to a total number of rerouting patches globally across the network.

4. The method as in claim 1, wherein the one or more size constraints comprise a router constraint that limits the set of rerouting patches to a maximum number of rerouting patches to be applied to a particular router in the network.

5. The method as in claim 1, wherein forming the set comprises:
consolidating two or more patches in the plurality to generate a new rerouting patch for inclusion in the set.

6. The method as in claim 1, wherein applying the objective function to the plurality of rerouting patches using the one or more size constraints comprises:
computing, for each of the patches in the plurality, an expected reward; and
ranking the patches in the plurality by their expected rewards.

7. The method as in claim 6, wherein the expected reward for a particular patch represents an amount of time that the particular patch would avoid a service level agreement violation or a number of sessions in the network that the particular patch would save.

8. The method as in claim 1, wherein the one or more size constraints comprise a constraint that limits the set of rerouting patches to a total number of rerouting patches per model of router in the network, geographic region in which the network is located, or an area of the network.

9. The method as in claim 1, further comprising:
providing, by the device, information regarding the set of rerouting patches to a user interface; and
receiving, at the device, an instruction via the user interface to adjust the set of rerouting patches or the one or more size constraints.

10. The method as in claim 1, further comprising:
obtaining, by the device, telemetry data indicative of network performance, after applying the set of rerouting patches to the network; and
adjusting, by the device and based on the telemetry data, how the device forms future sets of rerouting patches.

11. An apparatus, comprising:
one or more network interfaces;
a processor coupled to the one or more network interfaces and configured to execute one or more processes; and
a memory configured to store a process that is executable by the processor, the process when executed configured to:
obtain probabilities of service level agreement violations predicted to occur in a network;
generate, based in part on the probabilities, a plurality of rerouting patches for the network that reroute traffic in the network to avoid the service level agreement violations predicted to occur in the network;
form, based on the plurality, a set of rerouting patches that comprises at least a portion of the plurality, wherein the apparatus forms the set of rerouting patches by applying an objective function to the plurality of rerouting patches and using one or more size constraints; and
apply the set of rerouting patches to the network, prior to when the service level agreement violations are predicted to occur in the network.

12. The apparatus as in claim 11, wherein the network comprises a software-defined wide area network (SD-WAN).

13. The apparatus as in claim 11, wherein the one or more size constraints comprise a global constraint that limits the set of rerouting patches to a total number of rerouting patches globally across the network.

14. The apparatus as in claim 11, wherein the one or more size constraints comprise a router constraint that limits the set of rerouting patches to a maximum number of rerouting patches to be applied to a particular router in the network.

15. The apparatus as in claim 11, wherein the apparatus formats the set by:
consolidating two or more patches in the plurality to generate a new rerouting patch for inclusion in the set.

16. The apparatus as in claim 11, wherein the apparatus applies the objective function to the plurality of rerouting patches using the one or more size constraints by:
computing, for each of the patches in the plurality, an expected reward; and
ranking the patches in the plurality by their expected rewards.

17. The apparatus as in claim 16, wherein the expected reward for a particular patch represents an amount of time that the particular patch would avoid a service level agreement violation or a number of sessions in the network that the particular patch would save.

18. The apparatus as in claim 11, wherein the one or more size constraints comprise a constraint that limits the set of rerouting patches to a total number of rerouting patches per model of router in the network, geographic region in which the network is located, or an area of the network.

19. The apparatus as in claim 11, wherein the process when executed is further configured to:
provide information regarding the set of rerouting patches to a user interface; and
receive an instruction via the user interface to adjust the set of rerouting patches or the one or more size constraints.

20. A tangible, non-transitory, computer-readable medium storing program instructions that cause a device in a network to execute a process comprising:
obtaining, by the device in the network, probabilities of service level agreement violations predicted to occur in the network;
generating, by the device and based in part on the probabilities, a plurality of rerouting patches for the network that reroute traffic in the network to avoid the service level agreement violations predicted to occur in the network;
forming, by the device and based on the plurality, a set of rerouting patches that comprises at least a portion of the plurality, wherein the device forms the set of rerouting patches by applying an objective function to the plurality of rerouting patches and using one or more size constraints; and
applying, by the device, the set of rerouting patches to the network, prior to when the service level agreement violations are predicted to occur in the network.
